(19) United States
(12) Patent Application Publication
(10) Pub. No.: US 2015/0285952 A1
(43) Pub. Date: Oct. 8, 2015

(54) WEATHER FORECASTING SYSTEM AND METHOD

(71) Applicants: Raghav Gupta, Cupertino, CA (US); Haoran Guan, Sunnyvale, CA (US); Prachi Agarwal, Mountain View, CA (US)

(72) Inventors: Raghav Gupta, Cupertino, CA (US); Haoran Guan, Sunnyvale, CA (US); Prachi Agarwal, Mountain View, CA (US)

(73) Assignee: GeoTerrestrial, Inc. dba WeatherSphere, Mountain View, CA (US)

(21) Appl. No.: 14/518,993

(22) Filed: Oct. 20, 2014

Related U.S. Application Data
(60) Provisional application No. 61/867,612, filed on Aug. 20, 2013.

(51) Int. Cl. G01W 1/10; G06N 5/04

(52) U.S. Cl. CPC G01W 1/10; G06N 5/04

(57) ABSTRACT

A weather forecasting system and method. The system includes a mobile computing device that may request, from a server, real-time weather data at an exact time for a location. The real-time weather data include weather data from up to sixty minutes prior to the exact time. The system can predict future weather data for up to sixty minutes after the exact time. Weather maps of real-time and future weather data can be layered over each other and on selectable background maps such as terrain, roads, etc.

### CLAIM OF PRIORITY

The present application claims the benefit of and priority to U.S. Provisional Application No. 61/867,612 titled “WEATHER FORECASTING SYSTEM AND METHOD” filed on Aug. 20, 2013, and U.S. Provisional Application No. 61/867,616 titled “VIRTUAL METEOROLOGIST BASED ON WEATHER FORECASTING SYSTEM AND METHOD” filed on Aug. 20, 2013, each of which is hereby incorporated by reference in its entirety.

### CROSS REFERENCE TO RELATED APPLICATIONS

The present application is related to the following co-pending applications, each of which is hereby incorporated by reference in its entirety: U.S. application Ser. No. ______ titled “VIRTUAL METEOROLOGIST BASED ON WEATHER FORECASTING SYSTEM” filed on Oct. 20, 2014; and U.S. application Ser. No. ______ titled “NAVIGATION BASED ON WEATHER FORECASTING SYSTEM” filed on Oct. 20, 2014.

### BACKGROUND OF THE INVENTION

The present invention relates generally to communication and computer systems and methods and more specifically to communication and computer systems and methods for weather forecasting.

Severe weather such as lightning strikes, heavy snow, hurricanes and the like, can cause catastrophic property damage. Hundreds of thousands weather-related fatalities continue to occur each year.

Although many users have access to local weather forecasting services such as those provided by radio and television news reports, weather-related injuries and fatalities are yet to decline. Many users are unable to adapt conventional weather forecasting systems for their particular needs.

It is within the aforementioned context that a need for the present invention has arisen. Thus, there is a need to address one or more of the foregoing disadvantages of conventional systems and methods, and the present invention meets this need.

### BRIEF SUMMARY OF THE INVENTION

Various aspects of a weather forecasting system and method can be found in exemplary embodiments of the present invention.

In a first embodiment, the weather forecasting system can calculate the predicted motion of rain storms, clouds, lightning strikes, hurricanes and other similar weather type patterns and display them on a real-time basis using high definition graphics.

In the first embodiment, the system includes a mobile computing device (or other types of computing devices) that may request, from a server, real-time weather data at an exact time for a location. The real-time weather data include weather data from up to sixty minutes prior to the exact time. The system can predict future weather data for up to sixty minutes after the exact time. Weather maps of real-time and future weather data can be layered over each other and on selectable background maps such as terrain, roads, etc. Users may also select their locations, receive push notifications and alerts and otherwise adapt weather predictions for their own individual needs.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates a weather forecasting system according to an exemplary embodiment of the present invention.

FIG. 2A illustrates a predictive server system (real-time and adaptable) according to an exemplary embodiment of the present invention.

FIG. 2B illustrates an exemplary forecasting algorithm for use with the present invention, according to one embodiment.

FIG. 3 illustrates an exemplary computer architecture for use with an exemplary embodiment of the present invention.

FIG. 4 illustrates a screenshot of maps superimposed with weather data according to exemplary embodiments of the present invention.

FIG. 5 illustrates an exemplary contour map according to one embodiment of the present invention.

FIG. 6 illustrates a screenshot of maps superimposed with weather data according to exemplary embodiments of the present invention.

FIG. 7 illustrates a screenshot of maps superimposed with weather data according to exemplary embodiments of the present invention.

FIG. 8 illustrates a screenshot of maps superimposed with weather data according to exemplary embodiments of the present invention.

FIG. 9 illustrates a screenshot of maps superimposed with weather data according to exemplary embodiments of the present invention.

FIG. 10 illustrates a screenshot of maps superimposed with weather data according to exemplary embodiments of the present invention.

FIG. 11 illustrates a screenshot of maps superimposed with weather data according to exemplary embodiments of the present invention.

FIG. 12 illustrates a registration interface according to an exemplary embodiment of the present invention.

FIG. 13A illustrates an exemplary user customization interface for use with the present invention, according to one embodiment.

FIG. 13B illustrates an exemplary user customization interface for use with the present invention, according to one embodiment.

FIG. 13C illustrates an exemplary user customization interface for use with the present invention, according to one embodiment.

FIG. 14A illustrates an exemplary location selection interface for use with the present invention, according to one embodiment.

FIG. 14B illustrates an exemplary location selection interface for use with the present invention, according to one embodiment.

FIG. 14C illustrates an exemplary location selection interface for use with the present invention, according to one embodiment.

FIG. 15 illustrates an exemplary interface including indications of lightning strikes, according to an exemplary embodiment of the present invention.

FIG. 16 illustrates an exemplary interface including indications of lightning strikes, according to an exemplary embodiment of the present invention.

FIG. 17 illustrates a weather interface, according to an exemplary embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

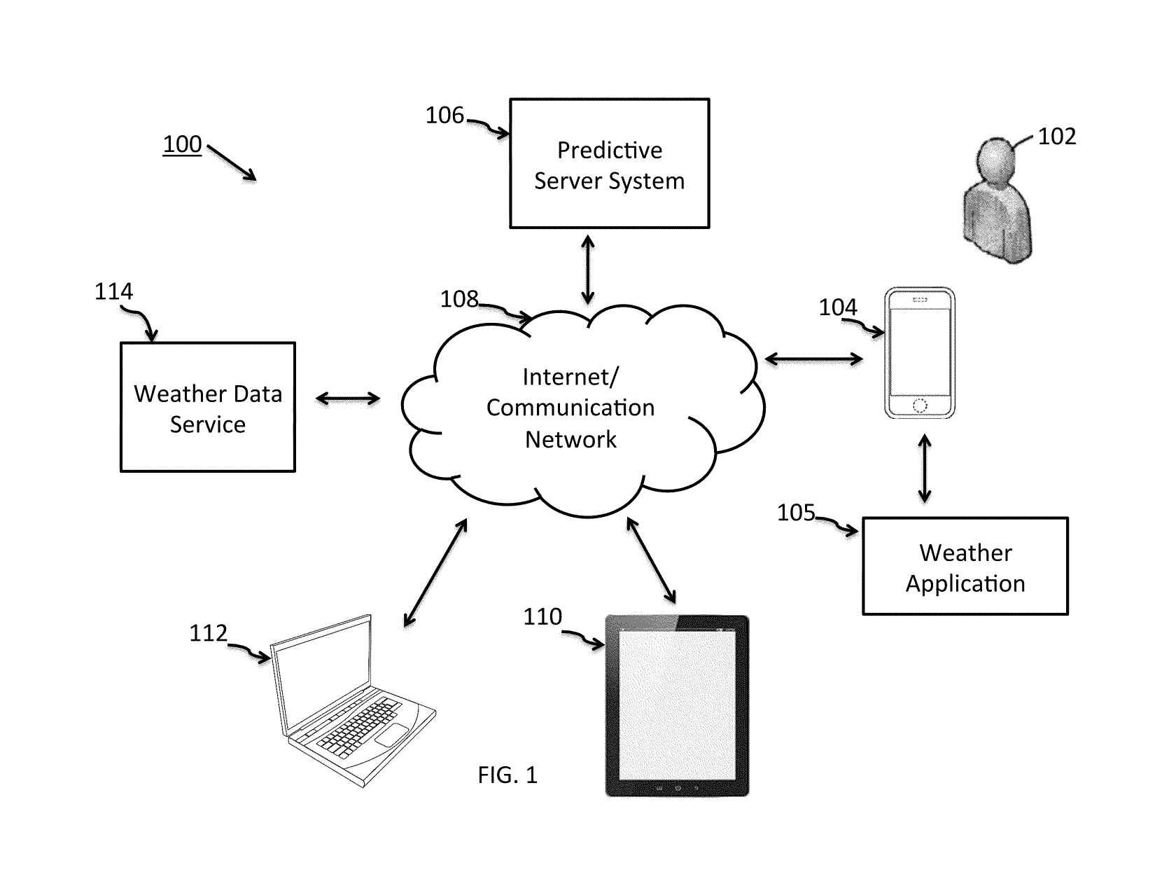

FIG. 1 illustrates weather forecasting system 100 according to an exemplary embodiment of the present invention.

In FIG. 1, weather forecasting system 100 is real-time and can be adapted or customized by users for their particular needs. Weather forecasting system 100 can calculate the predicted motion of rain storms, clouds, lightning strikes, hurricanes and other similar weather type patterns and display them on a real-time basis and on high definition graphics. Users may also select their locations, receive push notifications and alerts and otherwise adapt weather predictions for their own individual needs, as will be discussed in further detail below.

Weather forecasting system 100 includes user 102 having a mobile computing device 104 communicably coupled to predictive server system 106 via Internet/communication network 108. Device 104 can be a mobile communication device such as an iPhone™, a smart phone, or the like. It will be appreciated that a mobile communication or computing device referred to herein can also be replaced by a television or other display device having similar capabilities.

In FIG. 1, user 102 may also utilize another communication device namely device 110 to access the predictive server system 106 via Internet/communication network 108. User 102 may further employ computer 112 for access to the predictive server system 106. In turn, predictive server system 106 is itself communicably coupled to weather data service 114 via Internet/communication network 108. Although not shown herein in detail, weather data service 114 can be any service that provides weather data, water, and climate data, forecasts and associated warnings.

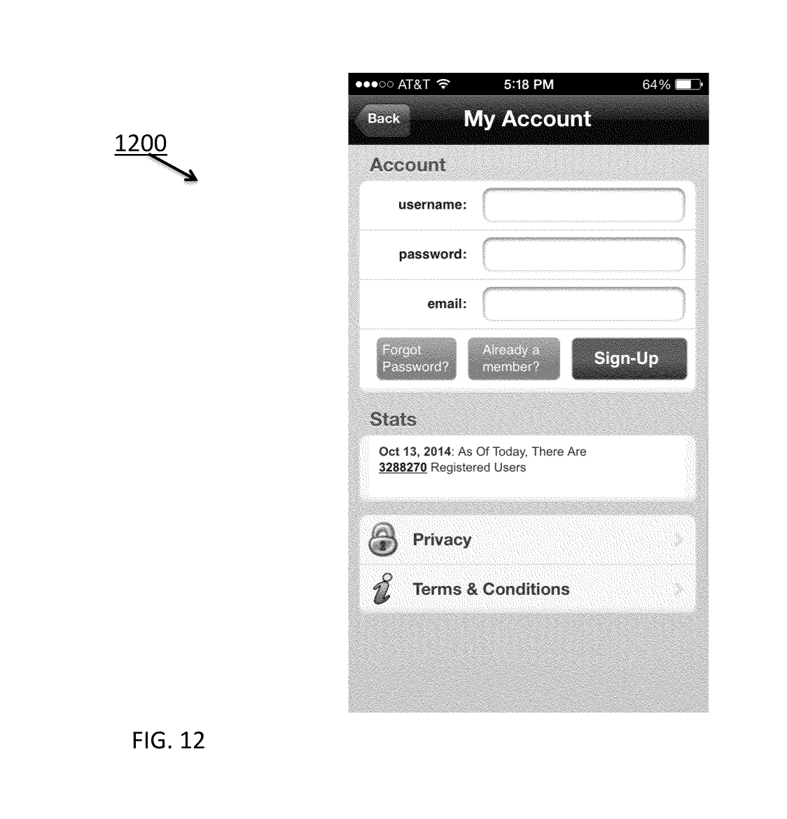

To initiate use of the system, user 102 employs device 104 to download weather application 105, and then registers to access predictive server system 106. FIG. 12 illustrates an exemplary interface 1200 for user registration. Upon registration, user 102 utilizes device 104 to launch weather application 105. Weather application 105 is also herein referred to as Radar Cast™ and may be available at Apple's™ App. Store or at www.weathersphere.com. It will be appreciated that Radar Cast™ is an exemplary and non-limiting embodiment of the present weather application 105.

Once weather application 105 is launched, user 102 can use weather application 105 on mobile device 104 to interact with predictive server system 106 to provide dynamic display of weather patterns on a real time basis as further described below. Display of weather patterns includes past, present, and future patterns. As noted, weather application 105, in conjunction with predictive server system 106, can calculate the predicted motion of rain storms, clouds, lightning strikes, hurricanes and other similar weather type patterns and display them on a real time basis and on stunning graphics displayed in sequence on device 104. Additional novel features and further illustration will be described with reference to the figures below.

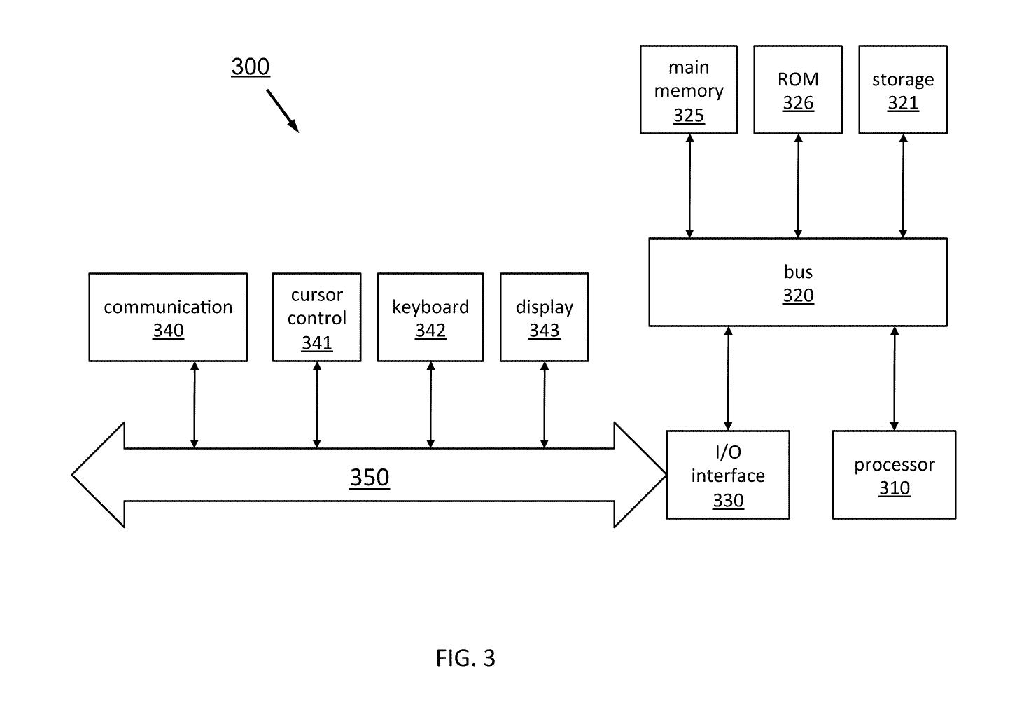

It will be appreciated that device 104, device 110, computer 112, as well as various other computing entities that comprise the inventive solution presented herein can have an architecture as so described below with respect to FIG. 3.

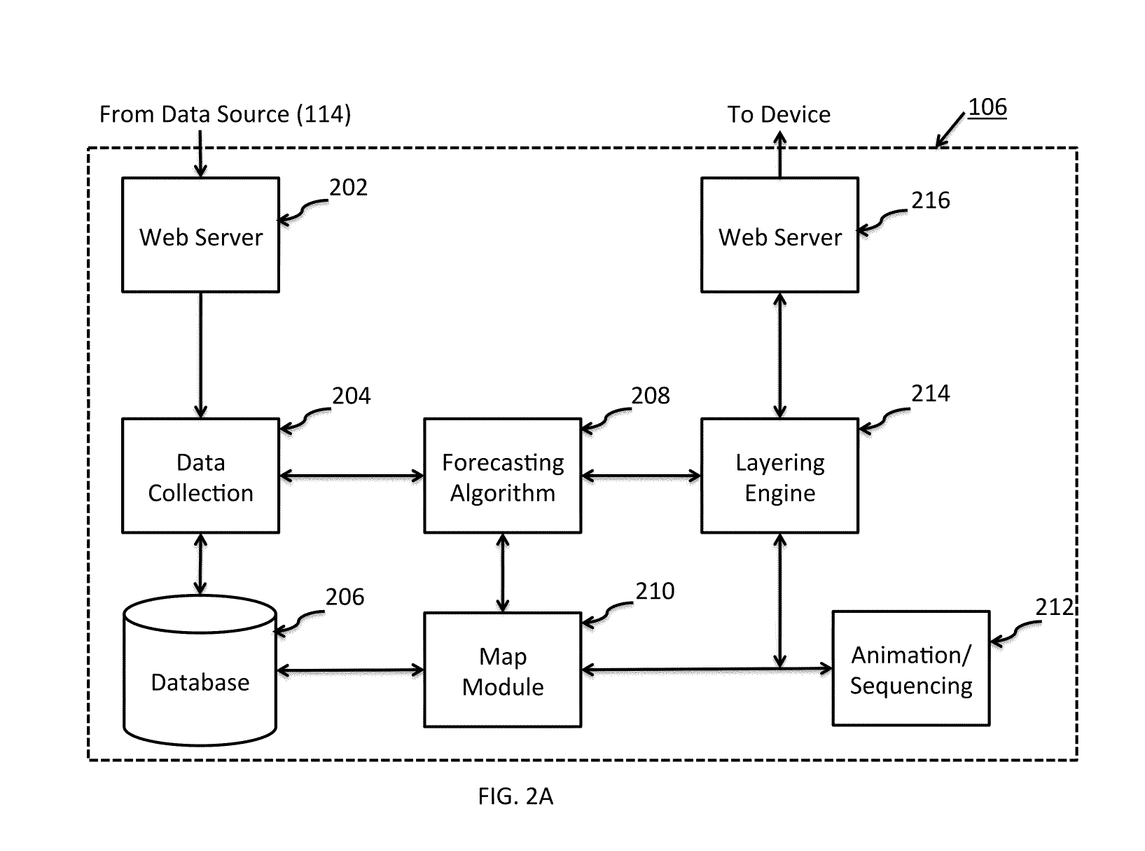

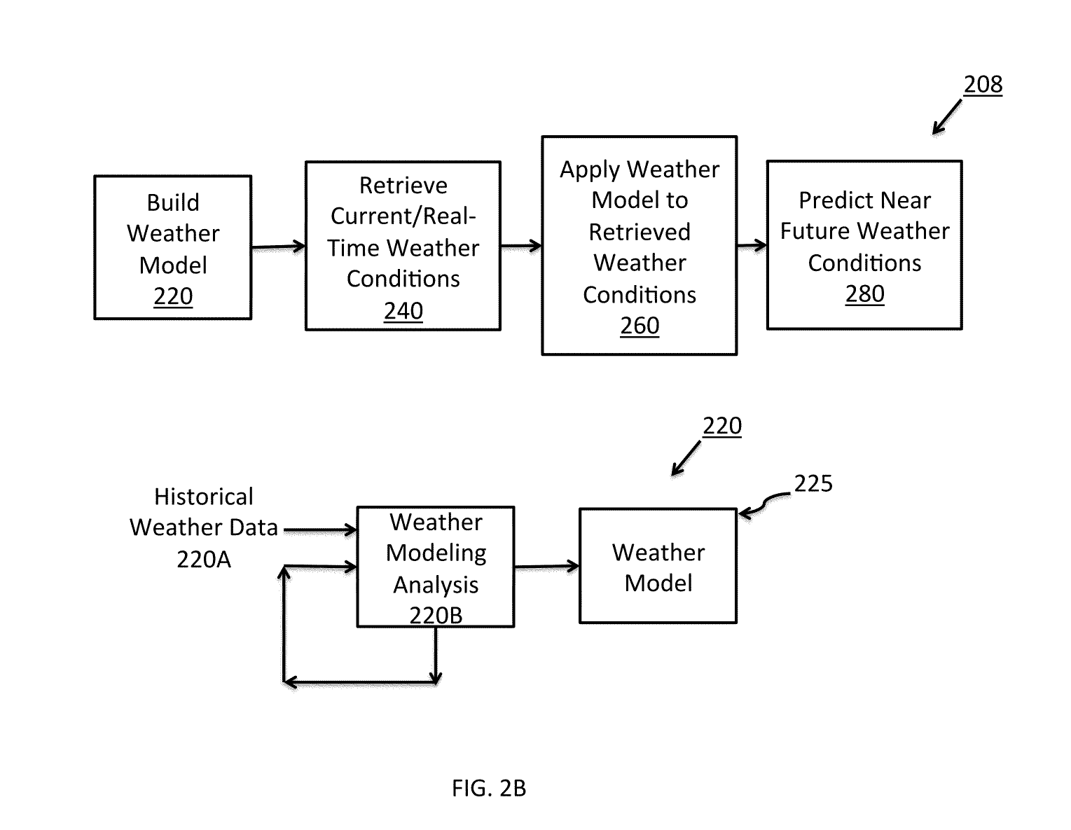

FIG. 2A illustrates predictive server system 106 of FIG. 1 according to an exemplary embodiment of the present invention.

In FIG. 2A, predictive server system 106 includes web server 202 that receives weather forecasting data from weather data service 114, for example. Weather data can also be received from additional sources or in lieu of weather data service 114.

Weather data received by web server 202 is transferred to data collection module 204. Data collection module 204 receives historical weather data for generation of a weather model, retrieves real-time weather conditions data, stores weather data in a database 206, and enables the use of the data on a real-time basis by forecasting algorithm 208. It will be appreciated that database 206 can be separate from or a part of a computing device employing data collection module 204 without departing from the scope of the present invention.

Predictive server system 106 also includes layering engine 214 that layers past, current and predicted weather data on a map generated by map module 210. The weather data may be hailstorms, rainfall, temperature, snowfall, drought, etc. The map generated may be background maps such as terrain, roads, etc. that are selectable by the user. Layering engine 214 layers the weather data on the background map selected by the user. The layering engine 214 receives user input indicating layers desired for display and renders the layers.

Animation/sequencing engine 212 animates and sequences multiple frames of weather data superimposed on maps generated by map module 210. The layered maps are then provided to a user device via web server 216. In one implementation, animation/sequencing engine 212 may render snapshots of two-dimensional data on the map in a time sequence. The data rendered may be observed data such as snowfall, precipitation, temperature; or it might be predicted data. Note that forecasts may also be generated quickly, depending on the data type to generate a seamless animation of past to future data. Predictive server system 106 and weather application 105 are further operable as described below.

FIG. 2B illustrates an exemplary forecasting algorithm 208 for use with the present invention, according to one embodiment.

Forecasting algorithm 208 involves initially building a weather model as shown at block 220. Specifically, a large amount of historical weather data 220A is fed through weather modeling analysis 220B that analysis the historical weather data 220A to generate a weather model 225.

At block 240, after the weather model 225 is generated, current or real-time weather data/conditions can be retrieved. At block 260, the weather model 225 is then applied to the current or real-time weather conditions. In this manner, near future weather conditions are predicted at block 280. Historical weather data and current or real-time weather data can be high-resolution precipitation information, either via Doppler radar echo strength or satellite images.

For example, consider real-time satellite images of clouds. The weather model 225, because of the historical data used to generate the model, can predict the motion, evolution, growth, reduction, expansion, or distortion of masses of gaseous or liquid fluids floating in another medium. If the system receives a few consecutive satellite images every predetermined period (30 seconds, 5-10 minutes, 20 minutes, 30 or 60 minutes, for example) of region having clouds, the forecasting algorithm 208 can determine the velocity and direction of movement of each cloud particle by examining the sequence of images. In one implementation, the system grids velocity information at a high resolution for each point in the cloud region. By applying the same velocity to the most recent actual image, the near future location of the cloud particles can be determined by extrapolation, for example.

It will be appreciated that the above example does not take into account other factors that can impact the movement of clouds, such as wind speed for the region, humidity, time of day, terrain, etc. The forecasting algorithm 208 takes all factors into account where possible. Further, it will be appreciated that the above example addresses the movement of clouds, however the predicted motion of rain storms, lightning strikes, hurricanes and other similar weather type patterns can also be determined using the present algorithm and system.

In one implementation, for certain weather regions, the forecasting algorithm 208 uses historical cloud motion information about that region to build a velocity grid pattern as it actually happened over the last 20 years. With current or recent weather data added to the velocity grid, a composite grid pattern that is highly accurate is obtained.

As an example of a specific calculation, for each type of data, whether it is cloud or rain intensity or wind speed or terrain elevation, a two-dimensional grid of that data for the region is determined; application of the algorithm then calculates a grid of same size, that at each point stores the velocity and direction of the data at that point (called the flow vector).

So, given a cloud image, and a two-dimensional flow vector of the same size as that image, for each pixel in the cloud image, the corresponding pixel in the flow vector specifies how by many pixels to displace the original cloud pixel in X and Y direction. By applying this calculation to each pixel in the original cloud image, we get a resulting cloud image in which each pixel's value came from some other location in the original image.

FIG. 3 illustrates an exemplary computer architecture for use with an exemplary embodiment of the present invention.

One embodiment of architecture 300 comprises a system bus 320 for communicating information, and a processor 310 coupled to bus 320 for processing information. Architecture 300 further comprises a random access memory (RAM) or other dynamic storage device 325 (referred to herein as main memory), coupled to bus 320 for storing information and instructions to be executed by processor 310. Main memory 325 also may be used for storing temporary variables or other intermediate information during execution of instructions by processor 310. Architecture 300 may also include a read only memory (ROM) and/or other static storage device 326 coupled to bus 320 for storing static information and instructions used by processor 310.

A data storage device 325 such as a magnetic disk or optical disc and its corresponding drive may also be coupled to architecture 300 for storing information and instructions. Architecture 300 can also be coupled to a second I/O bus 350 via an I/O interface 330. A plurality of I/O devices may be coupled to I/O bus 350, including a display device 343, an input device (e.g., an alphanumeric input device 342 and/or a cursor control device 341).

The communication device 340 allows for access to other computers (e.g., servers or clients) via a network. The communication device 340 may comprise one or more modems, network interface cards, wireless network interfaces or other interface devices, such as those used for coupling to Ethernet, token ring, or other types of networks.

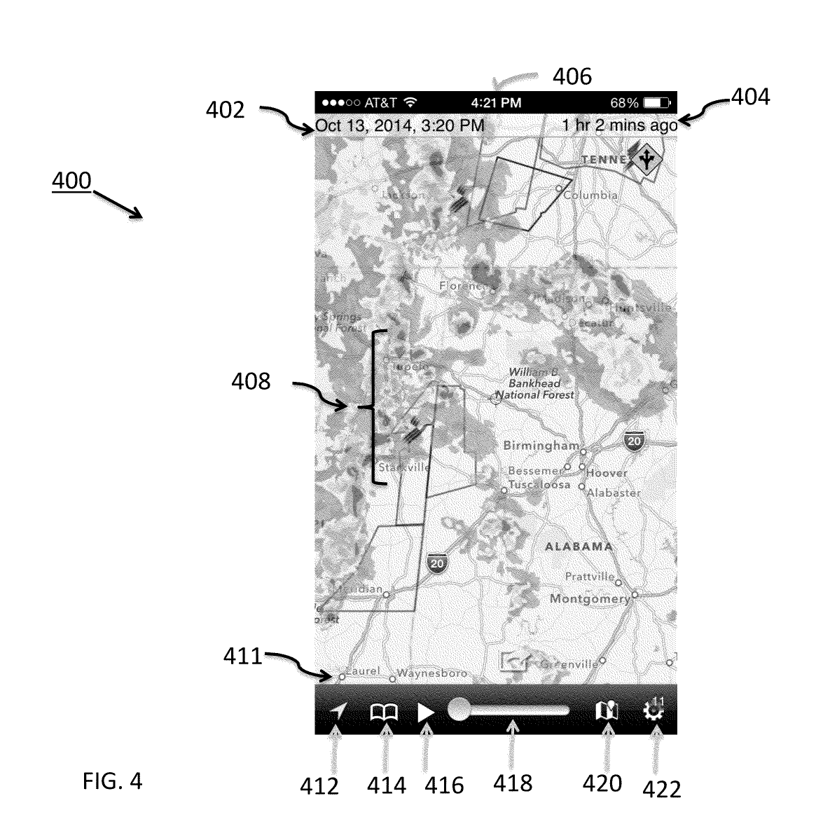

FIG. 4 illustrates a display of map 400 on a mobile computing device in accordance with an exemplary embodiment of the present invention. It will be appreciated that, while the illustrative displays presented herein are taken from a mobile computing device, the present disclosure is in no way limited to implementation on a mobile computing device.

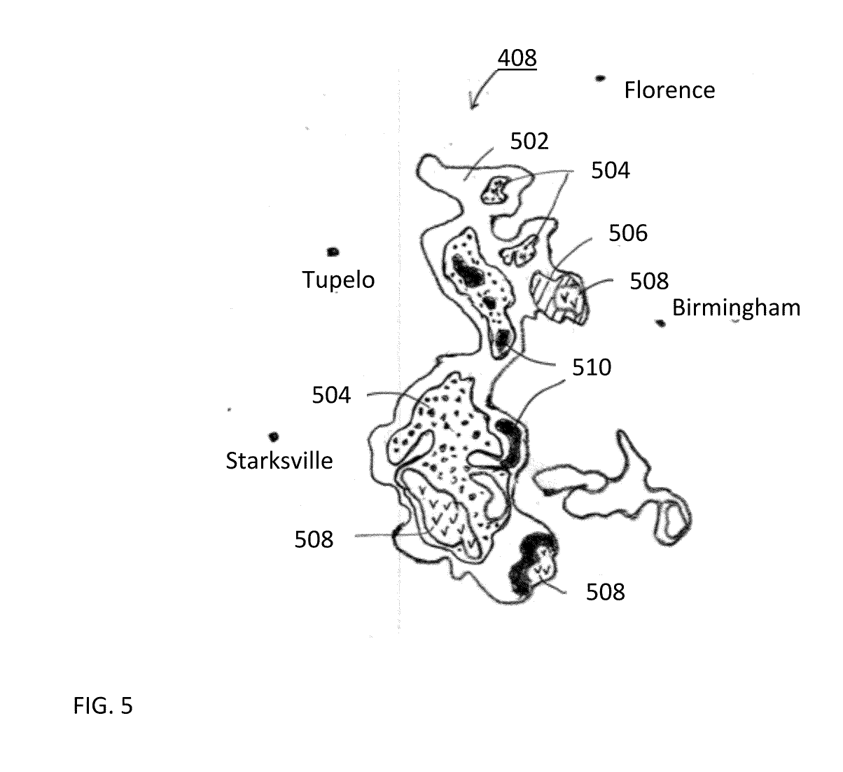

In FIG. 4, user 102 (FIG. 1) has downloaded weather application 105 (FIG. 1) to a mobile computing device 104 and has launched weather application 105 to generate map 400 as shown. Contour map 408 is also shown superimposed on map 300. Contour map 408 shows the geographical location of present, past or future event on map 400. Contour map 408 is further illustrated with reference to FIG. 5.

Another advantage of the present invention is that weather application 105 generates control interface 411 for manipulating movement of map 400 and selecting various options for adapting the map to the user's preference.

Control interface 411 includes location button 412 and pin button 414. Location button 412 is for location-based services and identifies the location of the device 104 on map 400 and provides associated past weather information and future weather information for that specific location. Pin button 414 permits user 102 to pin locations on map 400 so that weather information associated with the pinned location can be provided. Icon 414 also enables user 102 to use an address to identify a location.

Control interface 411 includes play button 416, forward/rewind button 418 and preferences button 420. As can be seen, play button 416 plays map frames with current and predicted weather data. Forward/rewind button 418 permits user 102 to forward or replay map frames. Preferences 420, among other functionalities, allow users to choose weather data layers that are superimposed on map 400.

User 102 can also employ weather application 105 on a computing device to instantaneously display a sequence of maps having historical and future weather data. As an example, contour map 408 is generated based on weather data that occurred 1 hour and 2 minutes ago, designated 404. The weather data was generated on Oct. 13, 2014, at 3:20 p.m. as shown at 402. As shown at 406, the current time is 4:21 p.m. Thus, weather application 105, in conjunction with predictive server system 106 has generated a frame with map 400 based on weather data that occurred sixty-two (62) minutes ago.

FIG. 5 illustrates contour map 408 according to an exemplary embodiment of the present invention.

In FIG. 5, contour map 408 defines the boundaries of weather events that occur according to the geographical location of such weather events. Contour map 408 shows that there has been weather activity between Tupelo, Starksville, Birmingham and Florence. Contour map 408 shows area 502 that represents light rain activity, area 404 that represents moderate rain activity and area 506 that represents moderate to severe rain activity.

Contour map 408 also shows area 508 that represents increasing rain activity and area 510 that represents very severe rain activity with severe thunderstorms. One skilled in the art will appreciate that different colors may be utilized to represent the shaded areas to indicate weather activity.

Other areas on the map can also represent snow activity from light snow to heavy snowfall. Contour map 408 can also represent minor flood advisories, moderate flood warnings, severe thunderstorms or extreme tornado warnings. In this exemplary embodiment, contour map 408 is based on weather data received from weather data service 114. In this manner, users can utilize contour map 408, which is displayed in high definition, to quickly determine areas on map 400 that have or might have severe weather.

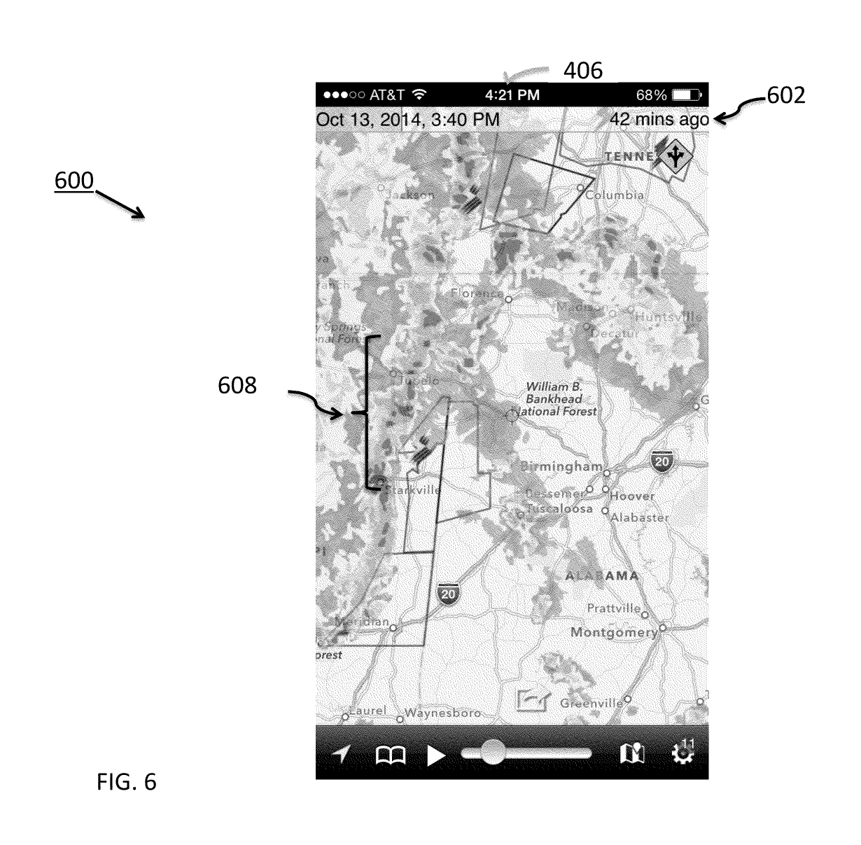

In FIG. 6, weather application 105 has generated another frame, map 600. Map 600 uses contour map 608 and weather data obtained forty-two (42) minutes ago as shown at 602. In this manner, animation/sequencing engine 212 (FIG. 2) can play the frames for map 400 (FIG. 4) and map 600 (FIG. 6) back to back.

As can be seen, map 400 and map 600 are played sequentially back to back at 4:21 PM, designated 406. Contour map 608, which evolved from contour map 408 of FIG. 4, shows that weather activity over Route 78 has dispersed although some activity appears to have moved closer to Tupelo.

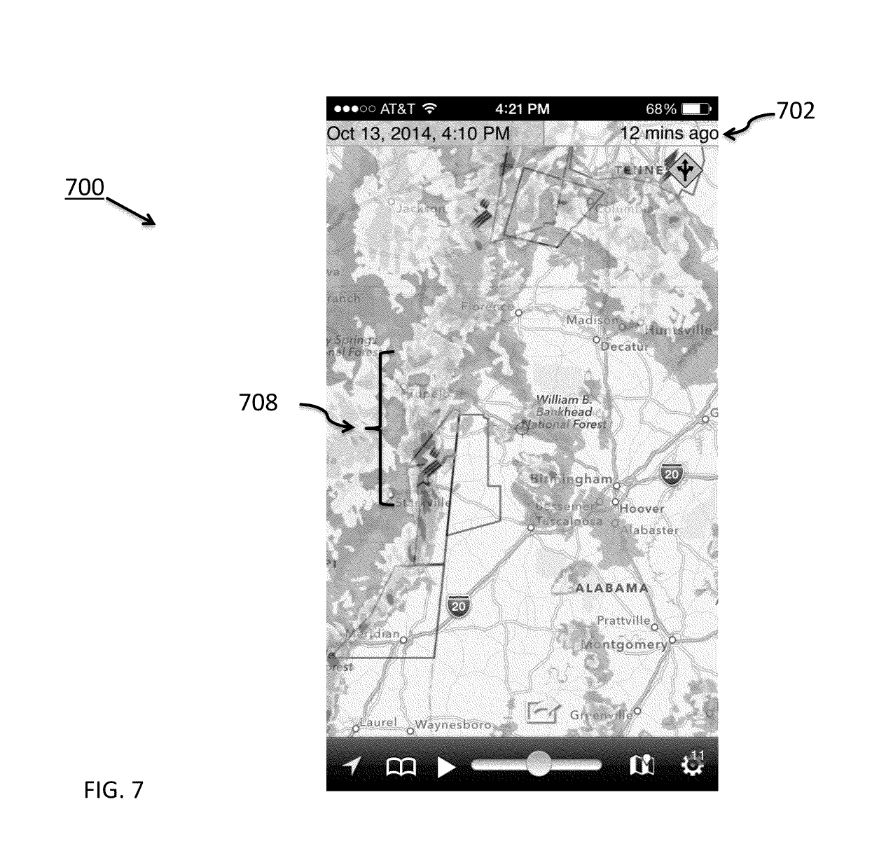

In the next sequence, as shown in FIG. 7, map 700 shows contour map 708 based on weather data obtained twelve (12) minutes ago, designated 702. Contour map 708 in FIG. 7 shows that weather activity has moved closer to Tupelo but away from Starksville.

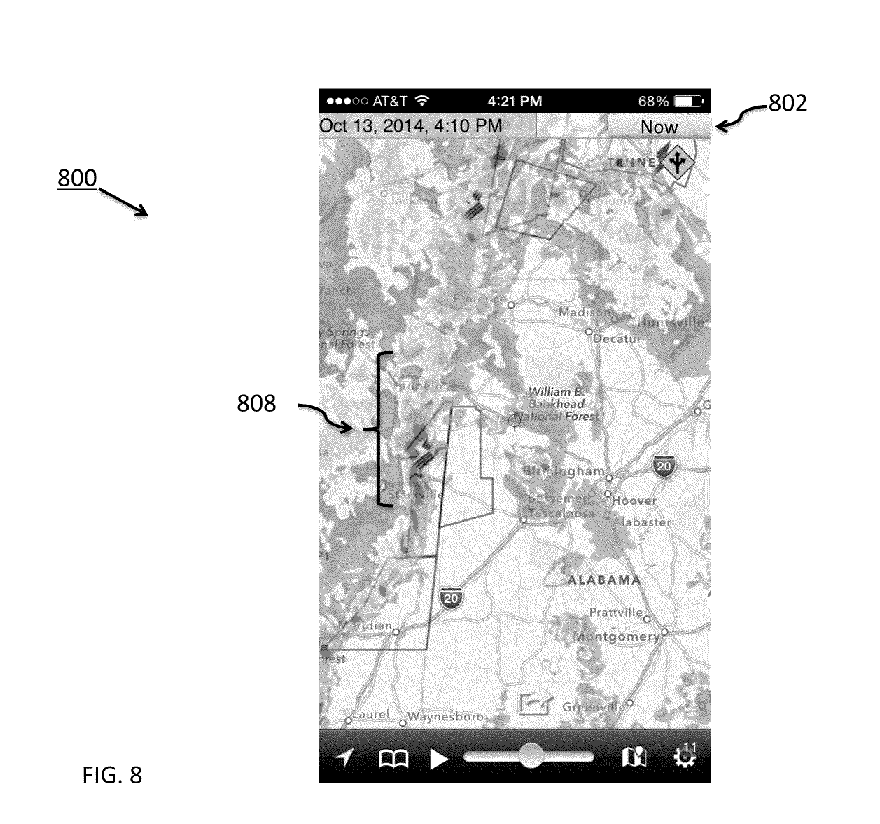

In the next sequence, in FIG. 8, contour map 808 is based on the present weather data as shown at 802. Contour map 808 shows that Tupelo is witnessing some weather activity now; there is some activity on Route 78 and no weather activity in Starksville.

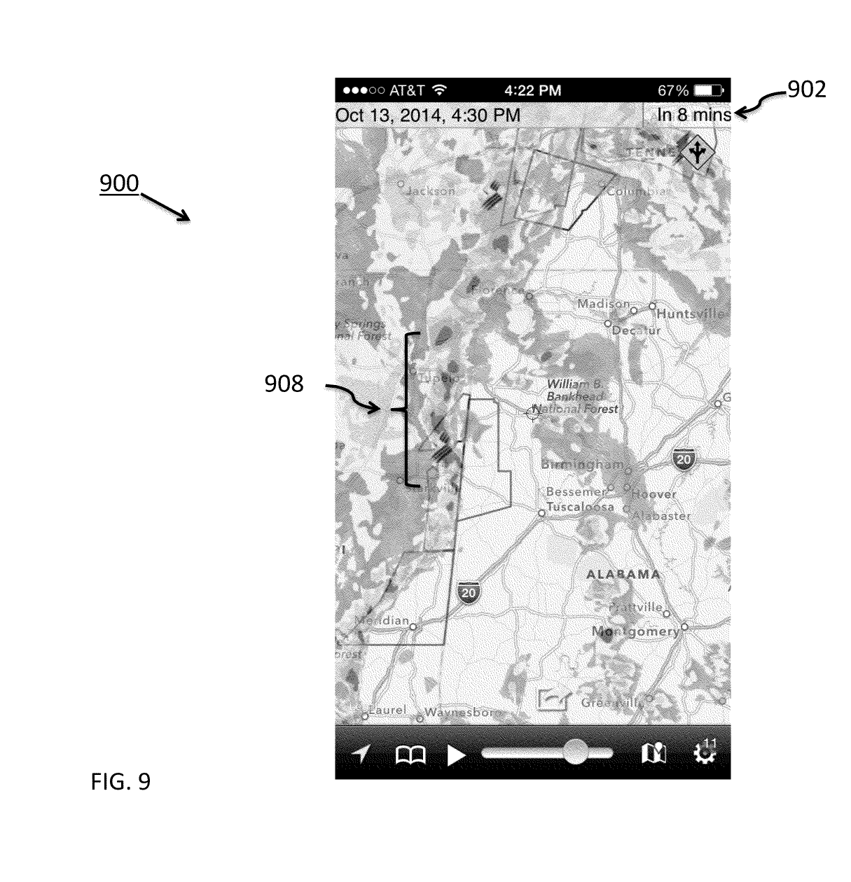

In the next sequence, in FIG. 9, another advantage of the present invention becomes apparent as contour map 908 is based on weather data extrapolated by predictive server system 106. Specifically, contour map 908 in map 900 is based on weather data that is predicted to occur in eight (8) minutes, designated as 902.

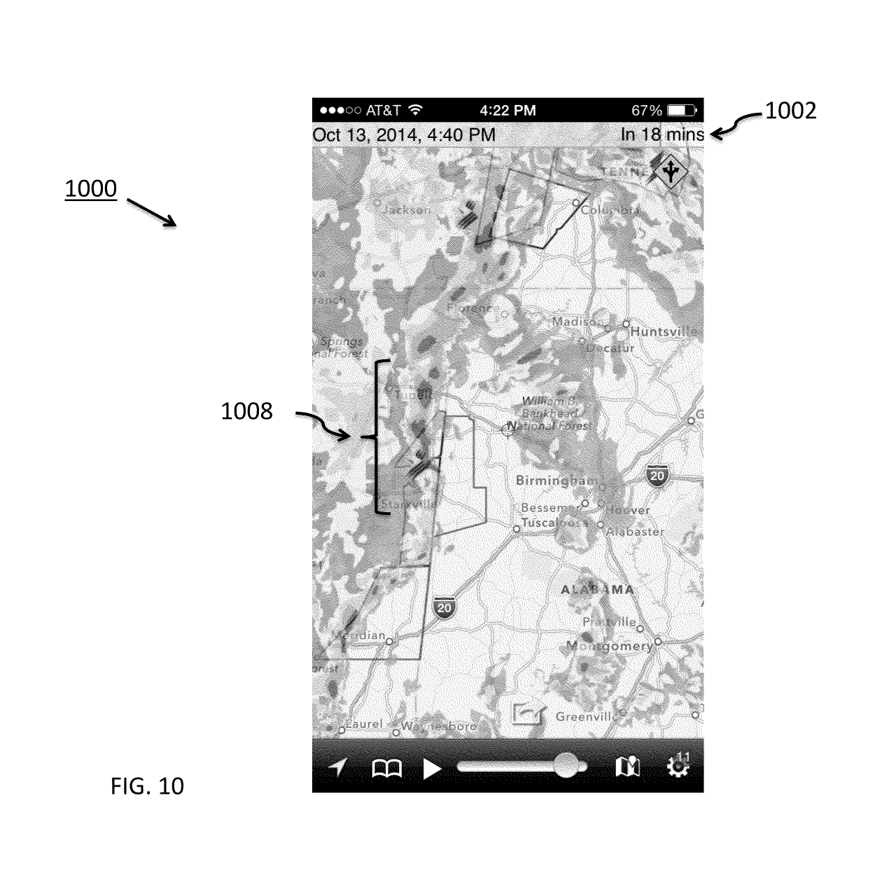

Here, it is predicted that Tupelo will continue to have weather activity in eight (8) minutes. In FIG. 10, contour map 1008 in map 1000 is based on weather data predicted to occur in eighteen (18) minutes, designated 1002. Here, it is predicted that in eighteen (18) minutes, Tupelo will no longer witness weather activity while Route 78 will see increased weather activity.

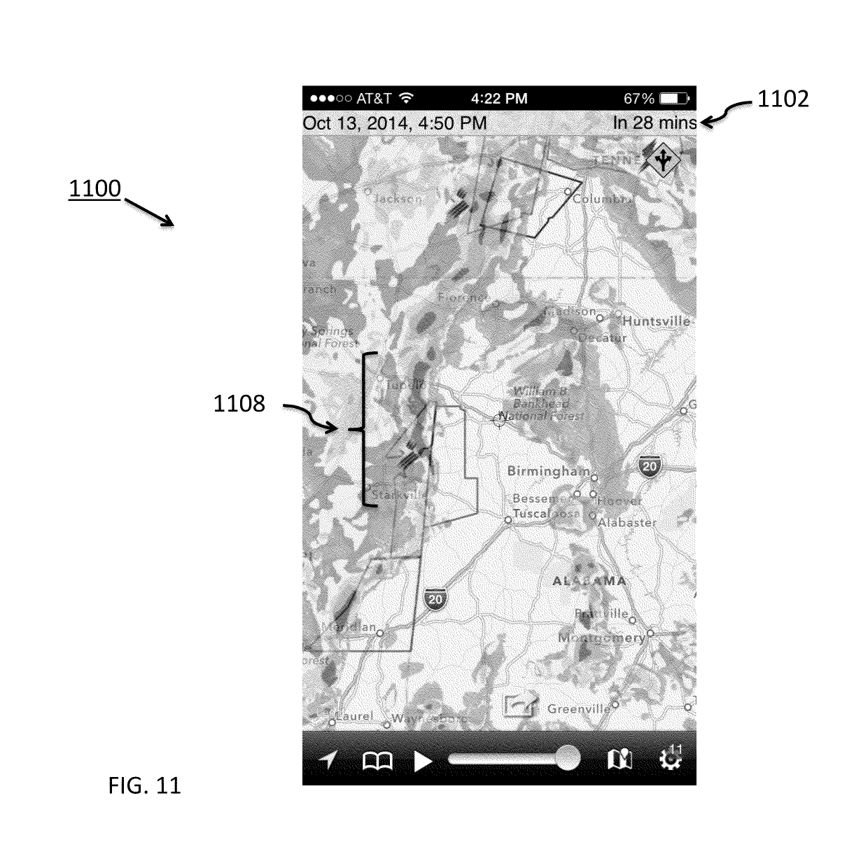

Next in the sequence, in FIG. 11, sequence map 1108 in map 1100 is based on weather data predicted to occur in twenty-eight (28) minutes as shown at 1102. Here, Tupelo will witness no weather activity while Route 78 will continue to see weather activity.

Thus, as can then be seen, user 102 can utilize weather application 105 on a computing device to generate, in one embodiment, weather maps superimposed with past and future weather data. Past weather data for at least over sixty (60) minutes ago can be generated. Future weather data for at least over sixty (60) minutes can be extrapolated. Superimposition of past weather data is not limited to sixty (60) minutes but the duration may be longer or shorter. Similarly, extrapolation of future data is not limited to sixty (60) minutes, but may be longer or shorter as well. All of the frames for the weather data are generated dynamically and played in sequence, one after the other. User 102 can moreover select the speed at which the weather map frames are played. Most importantly, real-time or current weather data can be data within the last one, two, five minutes or within seconds.

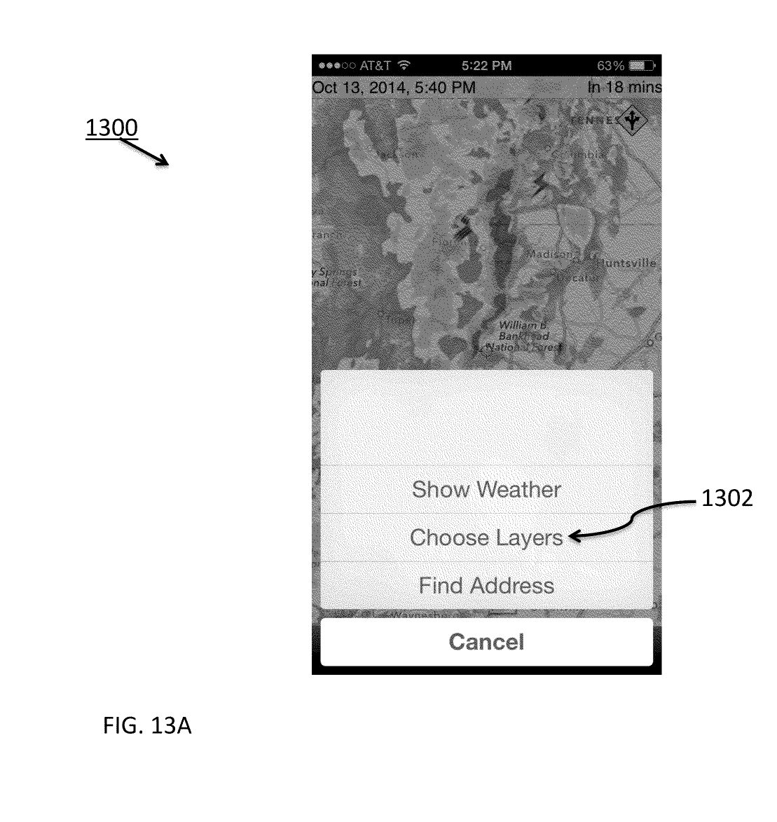

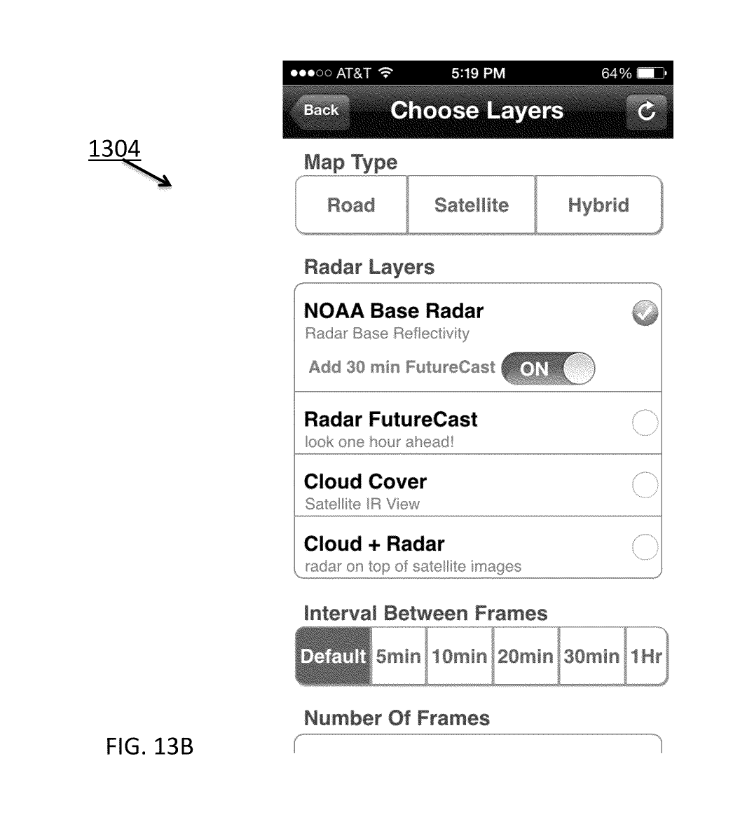

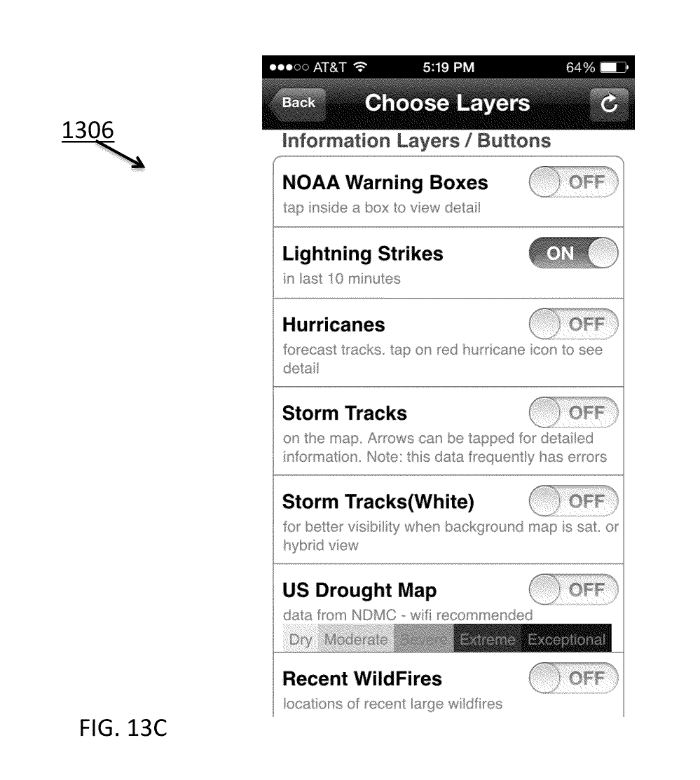

FIGS. 13A-13C illustrate exemplary user customizations for use with the present invention, according to one embodiment.

As shown in FIG. 13A, a weather application 105 presents an interface 1300 through which a user 102 can advantageously choose different layers 1302 of weather data that can be superimposed on map 400. For example, user 102 may choose to impose hurricane data, that is, locations where hurricanes have occurred and where hurricanes are predicted to occur in the future. Layers can include one or more of lightning strikes, hurricanes, drought, wildfires, storms, temperature, humidity, current conditions, multi-day forecasts, or precipitation.

As shown in FIG. 13B, user 102 selects display options from an interface 1304. FIG. 13B shows that a user may select a map type, from one or road, satellite, or hybrid. FIG. 13B further shows that a user may select the interval between frames, and the interval in this example can be one of 5 minutes, 10 minutes, 20 minutes, 30 minutes, or 60 minutes.

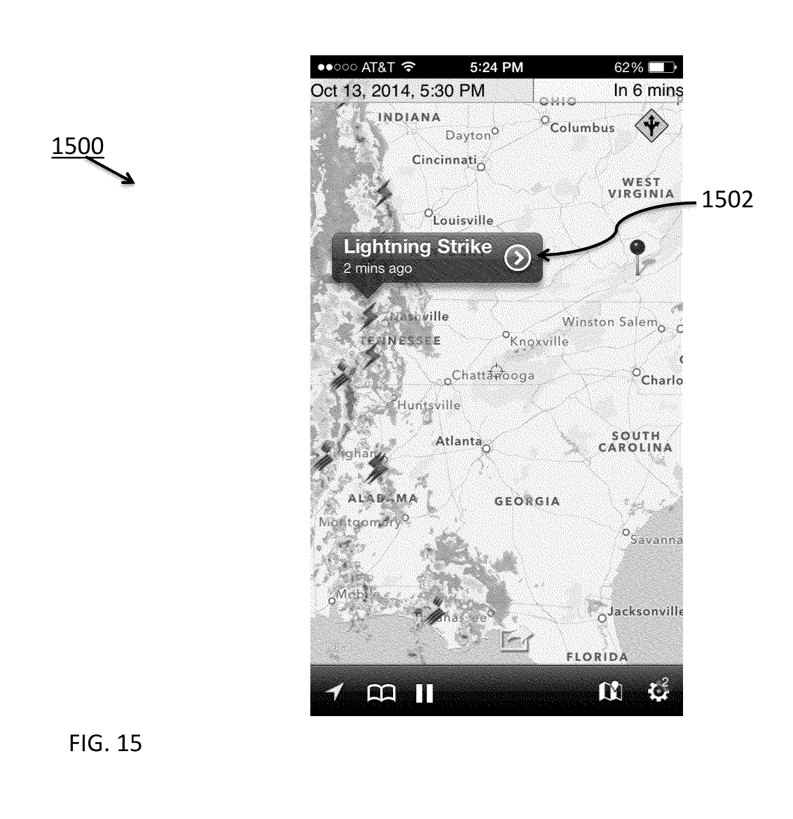

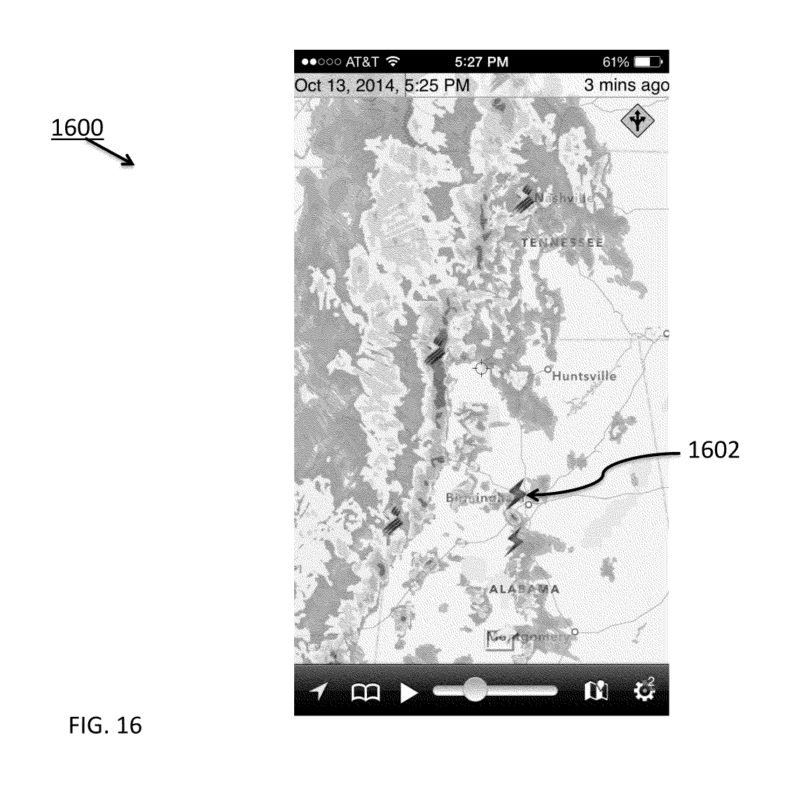

FIG. 13C further illustrates an interface 1306 through which user 102 may select layers. User 102 can choose to show predictive weather data, storm tracks, hurricanes, a drought map, recent wildfires, or may choose to show lightning strikes as shown with reference to FIG. 15, which is a map 1500 that illustrates lightning strikes indicated by 1502, for example. FIG. 16 also illustrates a map 1600 with an indication of a lightning strike 1602. User 102 can also show cloud cover, select intervals between frames, radar Doppler sites, Signets and travel/on-the-road weather data.

As discussed above with regard to FIG. 2B, weather application 105 uses actual real time precipitation data collected on the last few hours, uses historical trends of storms from the last few years, uses wind direction, uses elevation information and uses pressure gradient information to predict the motion of rain storms, clouds and other similar weather patterns. Although not shown, weather application 105 can use any and all types of weather data; weather data that can be used is not limited to the aforementioned weather data types.

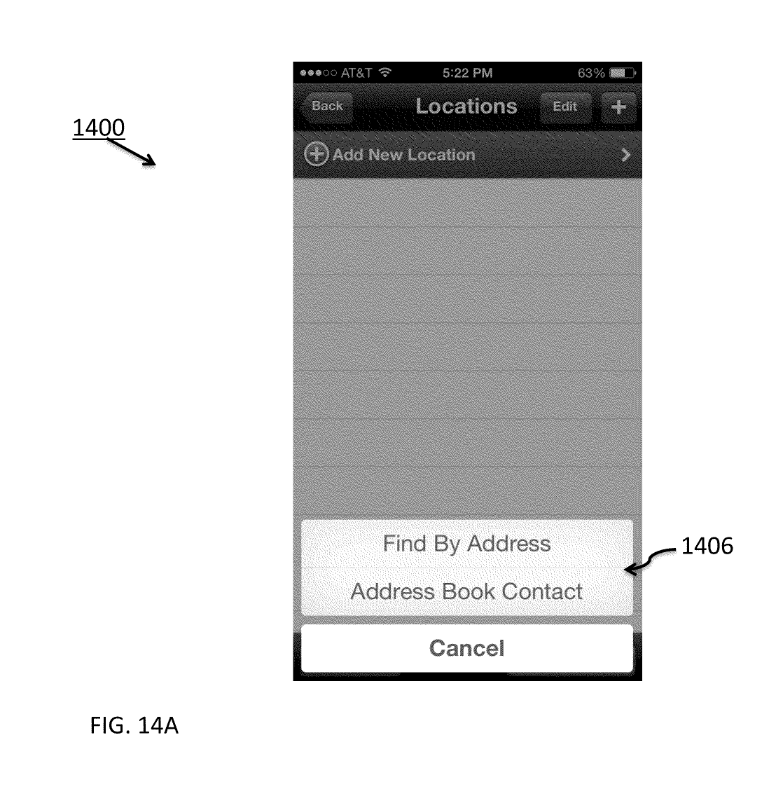

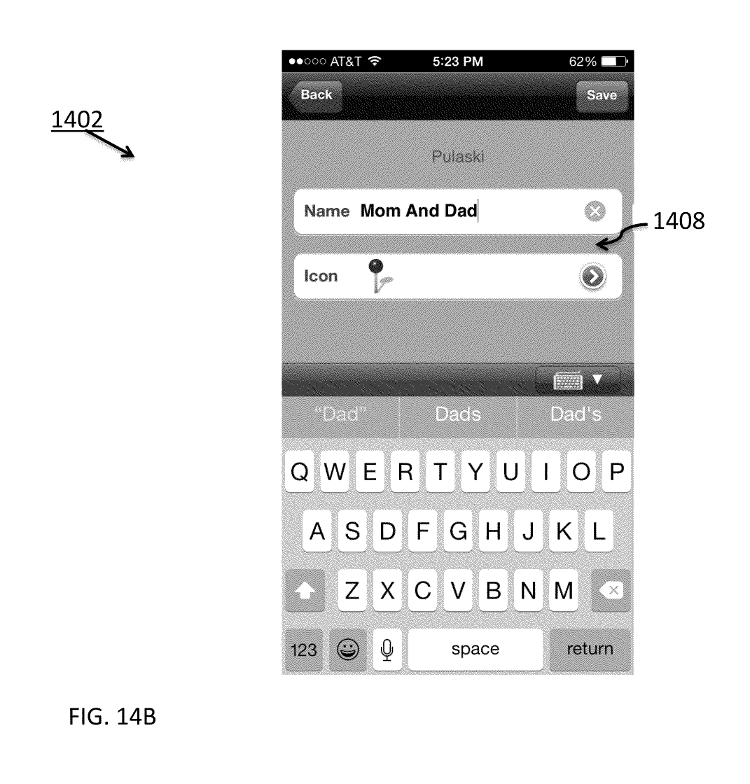

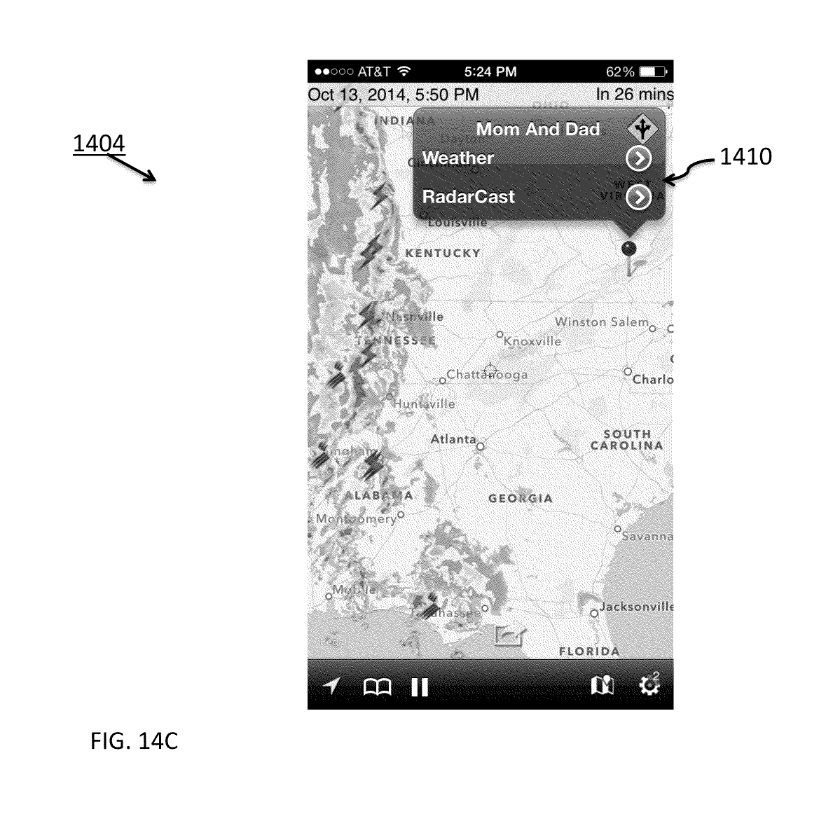

In FIGS. 14A-C, it is shown that weather application 105 enables user 102 to select any desired location on the underlying map. Interface 1400 provides selection 1406 of a location by address or by looking up in the address book of the computing device. Interface 1402 illustrates a user's ability to define locations of loved ones, Mom and Dad, 1408. Interface 1404 illustrates weather application 105 displaying the location 1410 of Mom and Dad on the map, as well as available options for viewing the weather where Mom and Dad are and predictive weather associated with their location.

As mentioned above, FIGS. 15-16 illustrate maps 1500 and 1600 having indications of lightning strikes 1502 and 1602, respectively.

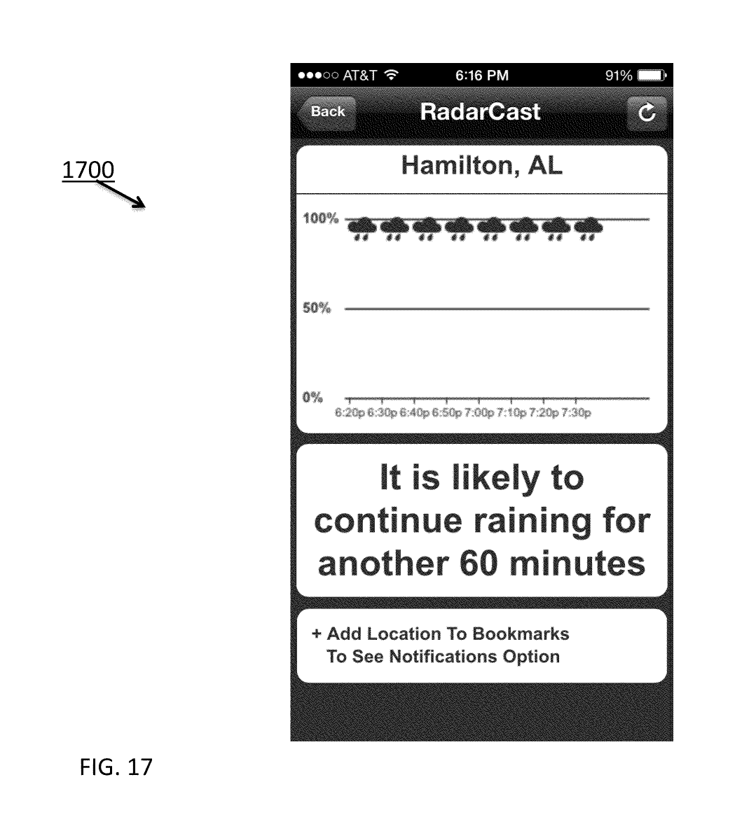

FIG. 17 illustrates an exemplary interface 1700 displaying predictive weather associated with a location.

While the above is a complete description of exemplary specific embodiments of the invention, additional embodiments are also possible. Thus, the above description should not be taken as limiting the scope of the invention, which is defined by the appended claims along with their full scope of equivalents.

What is claimed is:

1. A weather forecasting system, comprising:
a mobile computing device in communication with a server over a network, the mobile computing device comprising a computer readable memory having processor executable instructions stored thereon, the instructions for:
retrieving, at a specific time, real-time weather data for a location, the real-time weather data including weather data from up to sixty minutes prior to the specific time;
predicting future weather data for up to sixty minutes or more after the specific time by applying a weather model to the real-time weather data, wherein the weather model is generated using historical weather data associated with the location;
generating layers of weather maps based upon the real-time weather data and the future weather data, the layers being animated and generated in frames according to a predetermined periodic interval; and
displaying the layers of weather maps according to preferences as defined by a user of the mobile computing device, the layers of weather maps layered onto a map of the location.

2. The weather forecasting system of claim 1, wherein the predetermined periodic interval is selected by the user, and the interval is one of 5 minutes, 10 minutes, 20 minutes, 30 minutes, or 60 minutes.

3. The weather forecasting system of claim 1, wherein the map of the location is of a type selected by the user, and the type is one of road, satellite, or hybrid.

4. The weather forecasting system of claim 1, wherein the layers are one or more of lightning strikes, hurricanes, drought, wildfires, storms, temperature, humidity, or precipitation.

5. The weather forecasting system of claim 1, wherein the location is retrieved from an address book stored on the mobile computing device.

6. The weather forecasting system of claim 1, wherein the historical weather data and the real-time weather data include satellite images.

7. The weather forecasting system of claim 1, wherein the historical weather data and the real-time weather data include Doppler images.

8. A method of real-time weather forecasting, the method comprising:
retrieving, at a specific time, real-time weather data for a location, the real-time weather data including weather data from up to sixty minutes prior to the specific time;
predicting future weather data for up to sixty minutes after the specific time by applying a weather model to the real-time weather data, wherein the weather model is generated using historical weather data associated with the location;
generating layers of weather maps based upon the real-time weather data and the future weather data, the layers being animated and generated in frames according to a predetermined periodic interval; and
displaying the layers of weather maps according to preferences as defined by a user of the mobile computing device, the layers of weather maps layered onto a map of the location.

9. The method of claim 8, wherein the predetermined periodic interval is selected by the user, and the interval is one of 5 minutes, 10 minutes, 20 minutes, 30 minutes, or 60 minutes.

10. The method of claim 8, wherein the map of the location is of a type selected by the user, and the type is one of road, satellite, or hybrid.

11. The method of claim 8, wherein the layers are one or more of lightning strikes, hurricanes, drought, wildfires, storms, temperature, humidity, or precipitation.
